(19) United States
(12) Patent Application Publication
(10) Pub. No.: US 2026/0175191 A1
(43) Pub. Date: Jun. 25, 2026

(54) MULTI PURPOSE CONTAMINANT REMOVAL FROM FLUID STREAMS

(71) Applicant: Standard H2, Inc., Ravenna, OH (US)

(72) Inventors: Mariavicenta Wasas, Aurora, OH (US); James Wasas, Aurora, OH (US); Terry Mazanec, Solon, OH (US)

(21) Appl. No.: 19/421,760

(22) Filed: Dec. 16, 2025

Related U.S. Application Data
(60) Provisional application No. 63/736,668, filed on Dec. 20, 2024.

(51) Int. Cl. B01J 20/20; B01D 53/04; B01J 20/10; B01J 20/28; B01J 20/34; C02F 1/28; C02F 101/36

(52) U.S. Cl. CPC B01J 20/20; B01D 53/0415; B01D 53/0438; B01J 20/103; B01J 20/28004; B01J 20/2803; B01J 20/2805; B01J 20/3416; B01J 20/3433; B01J 20/3458; B01J 20/3475; C02F 1/281; C02F 1/288; B01D 2253/102; B01D 2253/1124; B01D 2259/4009; C02F 1/283; C02F 2101/36; C02F 2201/006; C02F 2303/16

(57) ABSTRACT

Processes for removing numerous undesirable contaminants from fluid streams using a fluid filter, filtering medium compositions, and filtering devices.

### CROSS REFERENCE TO RELATED APPLICATIONS

This application claims priority to U.S. provisional patent application 63/736,668, filed Dec. 20, 2024.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The invention comprises processes for removing numerous undesirable contaminants from fluid streams using a fluid filter, related filtering medium compositions and filter devices.

According to the US EPA, per-and polyfluoroalkyl substances (PFAS) are a broad class of approximately 10,000 synthetic chemicals present in numerous household and industrial products including carpeting, clothing, cookware, cosmetics, electronics, fire-fighting foam, glass, and packaging. The manufacture of PFAS and PFAS-containing products, along with the use and disposal of these products, have resulted in PFAS being released to air, soil, and water where the same properties that make PFAS useful in industry and commerce also make them stable and persistent in the environment. Many PFAS are believed to have deleterious health effects. Most standard municipal drinking water treatment systems are not designed to filter out PFAS. PFAS are found in water from about half of municipal water systems in the USA.

Among the “Best Available Technologies” (BATs) for meeting the PFAS Maximum Contaminant Levels (MCLs) are granular activated carbon (GAC), anion exchange, reverse osmosis, and nanofiltration according to the US EPA. However, each of these technologies suffers from very significant drawbacks. Granular activated carbon complications include PFAS displacement by other contaminants that are “stickier” (e.g., total organic carbon), release of certain metals (particularly arsenic, antimony, and iron), pH fluctuation, and reductions in disinfectant residual concentrations. PFAS removal by anion exchange is strongly pH dependent and better removal is generally achieved with more acidic water. Membranes used in reverse osmosis or nanofiltration require cleaning to prevent scaling or fouling. Capital and operational costs of high-pressure membranes are very high, and major challenges associated with these processes include brine disposal and corrosion. Moreover, none of these technologies is capable of significantly reducing the sulfur content of wastewater streams.

GAC filtration techniques have been favored as they are easy to operate at relatively low cost, but they require voluminous installations. Belkouteb et al, Water Research, 182 (2020) 115913, p 1-10 illustrates the use of GAC for removal of PFAS from wastewater together with problems related to GAC. A significant problem with GAC is that small sized carbon microparticles are released during the process, bringing contaminants into the outgoing water stream. Another problem is that GAC is not easily regenerable.

Activity in the search for materials to remove PFAS from wastewater has increased greatly in the past few years and can be expected to continue to grow as the limit of some PFAS permitted in drinking water is reduced from 70 to 4 ppt (parts per trillion) in 2029. Most work is focused on activated carbon (AC) and some have observed that increased concentrations of cations like calcium or ammonium in AC leads to increased PFAS removal, as in U.S. Pat. No. 11,911,743 to Calgon and U.S. Pat. No. 12,024,442 to Evoqua.

About 18% of the US is not served by city water systems that are generally effective at removing many contaminants from water, including most sulfur compounds. Where city water is not available, hydrogen sulfide or other sulfur compounds are often present in the water available from wells or ponds. Hydrogen sulfide arises from many sources including soil and rocks, biomass decay, sulfur-reducing bacteria present in groundwater, wells, or plumbing systems, runoff from human activities, such as sewage treatment, manure handling, petroleum refineries, landfills, gas and oil drilling operations, or coal fields. Private wells often have noxious odors due to the presence of hydrogen sulfide, which humans can smell at about 0.5 ppm in the water.

One of the very few mineral materials that has been evaluated for PFAS adsorption is sepiolite (sometimes called attapulgite), a naturally occurring, non-swelling, lightmass, porous clay with a large specific surface area. Sepiolite was only capable of removing PFAS when its surface was modified by the sulfur-containing mercapto-silane, 3-(trimethoxysilyl)-1-propanethiol, which is neither regenerable nor suitable for H2S removal, according to US 2024/0024847A1.

PFAS and H2S are materials that need to be removed to very low levels and there are no good examples of materials that can provide the versatility to meet and exceed future standards for both of these contaminants and can be regenerated. This invention discloses processes and materials with the versatility of removing hydrogen sulfide, other sulfur compounds, PFAS, and other contaminants from fluid streams using novel compositions and processes.

### Background of the Invention

Municipal wastewater streams typically contain a combination of liquid and solid contaminants from a variety of sources including municipal waste (i.e., raw sewage or wastewater), industrial waste, food processing waste, pharmaceutical waste, and the like. Insoluble contaminants can be physically separated and disposed of, and soluble contaminants can be biologically metabolized by bacteria in a two-stage process called an activated sludge process. In the first stage, a contaminated waste stream is contacted with activated sludge, which comprises microorganisms and a powdered adsorbent medium, typically activated carbon. After the bacteria break down the soluble contaminants, the activated sludge is allowed to settle, and a portion is recycled back into the process to seed further breakdown of waste, and the rest is disposed of. Unfortunately, gravity separation does not efficiently separate the activated sludge from the adsorbent medium. Practicing a once-through operation without reclaiming and recycling the adsorbent is costly and presents significant disposal problems.

Thermal regeneration by either wet oxidation or controlled incineration can provide a regenerated adsorbent for recycle to the treatment process. However, the regeneration processes destroy much of the activated carbon, significantly increasing the cost of the biological treatment system. Moreover, the activated sludge process does not efficiently remove PFAS from the wastewater. Other wastewater treatments that are ineffective at PFAS removal include low pressure membranes, biological treatment (including slow sand filtration), disinfection, oxidation, and advanced oxidation. City water often contains unacceptable concentrations of PFAS.

Sulfur contaminants can be removed from wastewater by reverse osmosis filters, oxidizing filters, or granulated activated carbon filters, but none of these filters is regarded as particularly effective, and none are certified to be effective by any international certifying authority. What is needed is a simple, efficient and cost-effective method of removing hydrogen sulfide, organosulfur contaminants, water soluble cyanide compounds, PFAS, and other undesirable contaminants from well water and other fluids, to remove the unpleasant odor and deleterious health effects associated with such contaminants.

A need exists for a process and material that can effectively remove PFAS, sulfur compounds, or both, from water streams.

### BRIEF DESCRIPTION OF THE INVENTION

The invention is embodied in various preferred and alternate variations, as each of a process, a filtering medium composition, a filter block, a filter device, a filter cartridge and shaped filter bodies, as follows:

A process for purifying a contaminant-containing stream comprising: providing a filtering medium composition of granular particles ranging in size from about 0.001 mm to about 15 mm, or one or more shaped filter bodies, and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, wherein the fraction of copper oxides is at least 50% by mass, and wherein the atom ratio of the sum of magnesium, calcium, strontium, and barium to that of copper is at least equal to 0.02, passing a contaminant-containing stream through the fluid filter materials, and recovering the purified stream.

The process as disclosed, wherein the filtering medium comprises trace catalytic quantities of gold, palladium, or platinum, or some combination thereof, wherein the atom ratio of the sum of gold, palladium, and platinum to that of copper is at least 0.001, 0.005, 0.01, 0.02, or 0.05, or from 0.001 to 0.1, 0.001 to 0.05, 0.001 to 0.01, or 0.001 to 0.005, or less than 0.1, 0.05, 0.02, 0.01, or 0.05.

The process as disclosed, wherein the contaminant-containing stream is an aqueous stream.

The process as disclosed, wherein the contaminant-containing stream is a gas stream.

The process as disclosed, wherein the filter material is contained in a filter cartridge.

The process as disclosed, wherein the filter cartridge has a diameter three or more times larger than the input line diameter.

The process as disclosed, wherein the cartridge is three or more times longer than its diameter.

The process as disclosed, wherein the granular particles range in size from about 0.03 mm to about 3 mm.

The process as disclosed, wherein the filter medium composition is at least 80 mass % oxides of copper as determined by ICP-MS solution analysis of nitric acid digestions of the medium.

The process as disclosed, wherein the filtering medium composition is comprised of at least 90 mass % oxides of copper.

The process as disclosed, wherein the atom ratio of the sum of magnesium, calcium, strontium, and barium to that of copper is at least equal to 0.05, 0.1, 0.2, or 0.25.

The process as disclosed, wherein the composition of the filtering medium is recyclable or regenerable.

The process as disclosed, wherein the filtering medium composition is comprised of 0.1-20% activated carbon by total mass.

The process as disclosed, wherein the activated carbon is granular.

The process as disclosed, wherein the activated carbon is extruded or otherwise combined with the filtering medium composition to make a block filter or other shaped filter body or bodies.

The process as disclosed, wherein the cartridge is packed with at least 5% by total mass of filtering medium composition and 95% or less by total mass of activated carbon.

A process for purifying an aqueous stream, comprising: providing a filter cartridge for placement into a fluid filter housing in a fluid line, such fluid filter comprising a cartridge packed with a filtering medium composition of granular particles ranging in size from about 0.001 mm to about 15 mm, or one or more shaped filter bodies, and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, wherein oxides of copper comprise at least 50% of the filtering medium, and wherein the atom ratio of the sum of magnesium, calcium, strontium, and barium to that of copper is at least equal to 0.02, passing the aqueous stream through the fluid filter cartridge, and recovering the purified aqueous stream.

The process as disclosed, wherein oxides of copper comprise at least 80% of the filtering medium.

The process as disclosed, wherein: oxides of copper comprise at least 90% of the filtering medium.

The process as disclosed, wherein the atom ratio of the sum of magnesium, calcium, strontium, and barium to that of copper is at least equal to 0.05, 0.1, 0.2, or 0.25.

The process as disclosed, wherein the filter cartridge comprises between 0.1%-20% by mass activated carbon.

The process as disclosed, wherein the activated carbon contains 0.01% to 20% by mass of one or more oxides of magnesium, calcium, strontium, and barium.

The process as disclosed, wherein the filtering medium comprises trace catalytic quantities of gold, palladium, or platinum, wherein the atom ratio of the sum of gold, palladium, and platinum to that of copper is at least 0.001, 0.005, 0.01, 0.02, or 0.05, or from 0.001 to 0.1, 0.001 to 0.05, 0.001 to 0.01, or 0.001 to 0.005, or less than 0.1, 0.05, 0.02, 0.01, or 0.05.

A process for purifying a water stream using the disclosed filter material, comprising: 1) a preliminary treatment to remove settleable organic and inorganic solids by sedimentation, and materials that will float (scum) by skimming, 2) a first clarifying step to remove particles that settle, 3) an aeration step that facilitates microbial degradation of organic materials, 4) an optional clarifier step, 5) an optional nitrification step, and 6) one or more filtration steps that include a filtration step using the disclosed filter material.

A process for removing PFAS compounds from an aqueous stream that reduces the concentration of PFAS by at least 90% of the initial PFAS concentration comprising: providing a fluid filter comprising a filter housing in which is placed a replaceable filter cartridge that is packed with a filtering medium composition of granular particles ranging in size from about 0.001 mm to about 15 mm, or one or more shaped filter bodies, and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, wherein the fraction of copper oxides is at least 50% by mass, and wherein the atom ratio of the sum of magnesium, calcium, strontium, and barium to that of copper is at least equal to 0.02, passing a contaminant-containing stream through the fluid filter, and recovering the purified stream.

The process as disclosed, wherein the filtering medium comprises trace catalytic quantities of gold, palladium, or platinum, wherein the atom ratio of the sum of gold, palladium, and platinum to that of copper is at least 0.001, 0.005, 0.01, 0.02, or 0.05, or from 0.001 to 0.1, 0.001 to 0.05, 0.001 to 0.01, or 0.001 to 0.005, or less than 0.1, 0.05, 0.02, 0.01, or 0.05.

A process for purifying aqueous streams, wherein the disclosed filter material is one of a series of filtering media used to remove contaminants from a fluid stream, wherein the other filtering media can be one or more of activated carbon, charcoal, biochar, peat, wood or forestry waste, agricultural waste, fruit or vegetable shells such as coconut shells, pistachio shells, peanut shells, or other shells, clay or treated clay, zeolites, alumina-silica mixtures, layered double hydroxides, hydrotalcite, ion-exchange resins, or similar porous materials.

The process as disclosed, wherein the fluid filtering process is one of a series of filtering processes used to remove contaminants from a fluid stream, wherein the other process is one or more of an activated sludge process, reverse osmosis filters, oxidizing filters, low pressure membranes, biological treatment (including slow sand filtration), or the like.

The process as disclosed, wherein the fluid filtering process is conducted after the other filtering process or processes.

The process as disclosed, wherein the sum of the concentrations of all PFAS in the purified stream is less than 10, 4, 1, 0.5, 0.2, 0.1, or 0.05 ppb by mass.

The process as disclosed, wherein the purified stream has a concentration of perfluorooctanoic acid (PFOA) less than 4 ppt, or perfluorooctanesulfonic acid (PFOS) less than 4 ppt, or perfluorohexanesulfonic acid (PFHxS) less than 10 ppt, or hexafluoropropylene oxide-dimer acid (HFPO-DA or GenX) less than 10 ppt, or perfluorononanoic acid (PFNA) less than 10 ppt, or some combination thereof.

The process as disclosed, wherein the concentration of sulfur compounds in the product stream is less than 1000, 500, 100, 50, 10, 4, 1, 0.5, 0.2, 0.1, or 0.05 ppb sulfur.

A process for purifying natural gas, wherein the disclosed filter material is utilized in a process that may include 1) condensate and water removal from a natural gas stream, 2) acid gas removal, 3) dehydration—moisture removal, 4) mercury removal, 5) nitrogen rejection, 6) natural gas liquids (NGL) recovery, separation, fractionation, and treatment of NGLs, to provide a purified natural gas, wherein:
the acid gases removed in 2) are optionally filtered using the filter material described herein to trap sulfur containing gases, and/or the purified natural gas from 6) is further purified by filtering through the filter material to produce a purified natural gas, and a natural gas stream is recovered.

The process as disclosed, wherein the purified natural gas contains less than 1 ppm (parts per million), 100 ppb (parts per billion), 50 ppb, 10 ppb 5 ppb, 1 ppb, 100 ppt (parts per trillion), 50 ppt, 10 ppt, or 5 ppt, or from 1 ppt to 1 ppm, 10 ppt to 100 ppb, 50 ppt to 10 ppb, or 100 ppt to 1 ppb, all by mass sulfur in the natural gas stream.

A process for purifying synthesis gas wherein the filter material as disclosed is used in a process that may include 1) cooling a synthesis gas stream by heat exchange or quench, 2) scrubbing with water to remove particulates, 3) optionally hydrolyzing to convert COS to H2S, 4) scrubbing of acid gases, 5) dehydrating to produce a purified synthesis gas, and 6) collecting the purified synthesis gas, wherein: the acid gases removed in 4) are optionally filtered using the filter material described herein to trap sulfur containing gases, and/or the purified synthesis gas from 5) is further purified by filtering through the filter material described herein to produce a purified synthesis gas.

The process as disclosed, wherein the purified synthesis gas contains less than 1 ppm (parts per million), less than 100 ppb (parts per billion), 50 ppb, 10 ppb 5 ppb, or 1 ppb, or less than 500 ppt (parts per trillion), 200 ppt, 50 ppt, 10 ppt, or 5 ppt, or from 1 ppt to 1 ppm, 10 ppt to 100 ppb, 50 ppt to 10 ppb, or 100 ppt to 1 ppb, all by mass sulfur in the synthesis gas stream.

A process for purification of hydrogen, methane, light hydrocarbons, nitrogen, helium, carbon monoxide, argon, natural gas, or other gas, or some mixture thereof, wherein the disclosed filter material is used wherein the feed gas is 1) optionally cooled by heat exchange, 2) optionally scrubbed with water to remove particulates, and 3) purified by filtering through the filter material.

The process as disclosed, wherein the purified gas comprises less than 1 ppm (parts per million), less than 100 ppb (parts per billion), 50 ppb, 10 ppb 5 ppb, or 1 ppb, or less than 500 ppt (parts per trillion), 200 ppt, 50 ppt, 10 ppt, or 5 ppt, or from 1 ppt to 1 ppm, 10 ppt to 100 ppb, 50 ppt to 10 ppb, or 100 ppt to 1 ppb, all by mass sulfur.

A process for regenerating filter media comprising: providing filtering media of granular particles ranging in size from about 0.001 mm to about 15 mm and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, wherein the fraction of copper oxides is at least 50% by mass, wherein the atom ratio of the sum of magnesium, calcium, strontium, and barium to that of copper is 0.02 or higher, and wherein the filtering media have been used to remove contaminants from one or more fluid streams, and combusting the material in air or other oxygen-containing gas.

The process as disclosed, wherein the combustion is conducted at a temperature of at least 80, 90, 100, 110, 120, 130, 140, 150, 160, or 170 C, or from 80 to 250, 100 to 200, 120 to 180, or 130 to 170 C, or no more than 350, 320, 300, 280, 250, or 220 C, and wherein the temperature is controlled by diluting the air with inert gas such as N2, CO2, He, Ne, or an oxygen-depleted flue gas, or a mixture of these, to provide an oxygen-containing stream with less than 15, 10, 7, 5, or 2% by volume oxygen or from 0.1 to 15, 2 to 10, or 3 to 7% by volume oxygen.

The process as disclosed, wherein the regeneration process includes treating the material with a dilute basic or dilute acidic water stream wherein the pH of the water stream is no less than 5, 4.5, 4, 3.5, 3, or 2.5, or no more than 3, 3.5, 4, or 5 where it is an acidic stream, or no less than 8, 8.5, 9, 9.5, 10, or 10.5, or no more than 11, 10.5, 10, 9.5, 9, or 8.5 where it is a basic stream, or by treatment with such an acidic stream, and a separate treatment by such a basic stream, wherein either acidic or basic treatment or both can be before or after the combustion step.

The process as disclosed, wherein regenerated material recovers at least 50-90% of its initial capacity or from 50-99%, 60-95%, 65-90%, or 70-85% of its initial capacity.

The process as disclosed, wherein the material remains in a cartridge.

The process as disclosed, wherein the material is removed from the cartridge, regenerated, and then at least part of it is returned to service.

The process as disclosed, wherein the regenerated material is used to prepare fresh filter material by being dissolved in an acidic aqueous solution, contacted with enough solution of sodium or potassium hydroxide, bicarbonate, or carbonate, or a mixture of these, in water to form a homogeneous precipitate of hydroxides, carbonates, or both, which are optionally washed with water, then dried and calcined in air to convert the materials to oxides and drive off the unwanted materials, crushed and sieved to provide particles of filter media for further use.

The process as disclosed, wherein the filter medium has been regenerated one or more times.

The process as disclosed, wherein the used dilute acid or basic wash solution is concentrated to provide a more concentrated solution of sulfuric acid, sulfurous acid, or both.

The process as disclosed, wherein fluorinated materials are recovered from the used dilute acid or basic wash solution.

A filtering medium composition of granular particles ranging in size from about 0.001 mm to about 15 mm and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, wherein the fraction of copper oxides is at least 50% by mass, and wherein the atom ratio of the sum of magnesium, calcium, strontium, and barium to that of copper is at least equal to 0.02.

The filtering medium composition as disclosed, wherein the atom ratio of the sum of magnesium, calcium, strontium, and barium to that of copper is 0.02, 0.05, 0.1, 0.2, 0.25, 0.4, 0.5, or at least equal to 0.05, 0.1, 0.2, or 0.25.

The filtering medium composition as disclosed, wherein the filtering medium composition is comprised of 0.1, 0.5, 1.0, 3, 5, 8, 10, or 15 mass % activated carbon or 0.1-20, 0.5 to 20, 3 to 20, or 5 to 15 mass % activated carbon.

The filtering medium composition as disclosed, wherein the activated carbon is comprised of at least 0.1, 0.5, 1.0, 3, 5, 8, 10, or 15 mass % of the sum of magnesium, calcium, strontium, and barium or 0.1 to 20, 0.5 to 20, 3 to 20, or 5 to 15 mass % of the sum of magnesium, calcium, strontium, and barium.

The filtering medium composition as disclosed, wherein the oxides of magnesium, calcium, strontium, or barium are added to pre-existing granular particles ranging in size from about 0.001 mm to about 15 mm, or one or more shaped filter bodies, and comprising a mixture of the oxides of copper and one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, wherein the fraction of copper oxides in the pre-existing granular particles is at least 50% by mass, and wherein the atom ratio of the sum of magnesium, calcium, strontium, and barium to that of copper in the filtering medium is at least equal to 0.02.

The filtering medium composition as disclosed, wherein the filtering medium comprises catalytic quantities of gold, palladium, or platinum wherein the atom ratio of the sum of gold, palladium, and platinum to that of copper is at least 0.001, 0.005, 0.01, 0.02, or 0.05, or from 0.001 to 0.1, 0.001 to 0.05, 0.001 to 0.01, or 0.001 to 0.005, or less than 0.1, 0.05, 0.02, 0.01, or 0.05.

The filtering medium composition as disclosed, wherein the average particle size of the filtering medium is from 0.01 mm (0.0004 inch) to 50 mm (2 inch), 0.05 mm (0.002 inch) to 25 mm (1 inch), 0.1 mm (0.004 inch) to 15 mm (0.6 inch), 0.1 mm (0.004 inch) to 5 mm (0.2 inch), 0.5 mm (0.02 inch) to 2.5 mm (0.1 inch), 5 mm (0.2 inch) to 15 mm (0.6 inch), or 10 mm (0.4 inch) to 25 mm (1 inch), where particle size is measured by dynamic image analysis (DIA), static laser light scattering (SLS, also called laser diffraction), dynamic light scattering (DLS) or sieve analysis, or can pass through sieve size 2 inch (5 cm), 1 inch (2.5 cm), 0.5 inch (1.25 cm), US ASTM Standard Sieve size 4 (4.75 mm), 10 (2.00 mm), 14 (1.40 mm), 18 (1.00 mm), 35 (0.50 mm), 70 (0.212 mm), or US sieve size 140 (0.106 mm), but cannot pass through US ASTM Standard sieve size 500, 270, 140, 70, 35, 18, 14, 10, or 4, or 0.5 inch (1.25 cm).

The filtering medium composition as disclosed, wherein the surface area of the particles is at least 10, 15, 25, 50, 75, 100, 200, 300, 400, or 500 m2/g, or from 10 to 1000, 20 to 500, or 15 to 30 m2/g when measured by Brunauer-Emmett-Teller (BET) analysis using N2 adsorption.

The filtering medium as disclosed, wherein the fraction of micropores (less than 2 nm) is at least 0.1, 0.2, 0.3, 0.4 or 0.5, or from 0.1 to 0.95, 0.2 to 0.8, 0.3 to 0.7, or 0.4 to 0.6, or less than 0.9, 0.8, 0.7, 0.6, 0.5, or 0.4 of the total pore volume as measured by mercury porosimetry or N2 absorption, or wherein the fraction of mesopores (about 2-50 nm) is at least 0.1, 0.2, 0.3, 0.4 or 0.5, or from 0.1 to 0.95, 0.2 to 0.8, 0.3 to 0.7, or 0.4 to 0.6, or less than 0.9, 0.8, 0.7, 0.6, 0.5, or 0.4 of the total pore volume as measured by mercury porosimetry or N2 absorption, or both.

The filtering medium as disclosed, wherein at least a portion of the copper and other metals have been recovered from regenerated filter materials.

The filtering medium as disclosed, wherein the filtering medium has been exposed to sulfur containing fluids and contains at least 5, 10, 20, 25, 30, 35, or 40% by mass sulfur or from 1 to 50, 5 to 45, 10 to 40, or 10 to 35% by mass sulfur.

The filtering medium as disclosed, wherein the filtering medium has been exposed to PFAS containing fluids and contains at least 0.001, 0.01, 0.1, 0.2, 0.5, 1, 2, 4, 8, 15, or 20 % by mass fluorine, or from 0.0001 to 20, 0.001 to 15, or 0.01 to 2% by mass fluorine.

A porous filter block composed of the filtering medium composition as disclosed, wherein the filtering medium is bound together with one or more agglomerating agents and in the shape of a filter cartridge.

The filter block as disclosed, wherein the agglomerating agent or agents are chosen from among polymers, silica sols, porous clay, starch, Isopropyl acetate, methyl cellulose, hexadecanol, octadecanol, paraffin, melted wax, silicone, epoxy resins, and polymerized furfuryl.

The filter block as dislcosed, wherein the agglomerating agent or agents include one or more thermoplastic polymers chosen from among epoxies, phenolics, polyacetals, polyacrylics, polyalkyls, polyamideimides, polyamides, polyanhydrides, polyaramides, polyarylates, polyarylsulfones, polybenzimidazoles, polybenzoxazoles, polybutadienes, polycarbonates, polydibenzofurans, polydioxoisoindolines, polyesters, polyether ether ketones, polyether ketone ketones, polyetherimides, polyetherketones, polyethyleneimines, polyethylenes, polyimides, polyisoprenes, polymethacrylonitriles, polymethyl methacrylates, polymethylacrylates, polyolefins, polyoxabicyclononanes, polyoxadiazoles, polyoxindoles, polyoxoisoindolines, polyphthalides, polypiperazines, polypiperidines, polypyrazinoquinoxalines, polypyrazoles, polypyridazines, polypyridines, polypyromellitimides, polyquinoxalines, polysilazanes, polystyrenes, polytriazines, polytriazoles, polyureas, polyurethanes, polyvinyl acetates, polyvinyl alcohols, polyvinyl esters, polyvinyl ethers, polyvinyl ketones, polyvinyl nitriles, polyvinylpyrrolidones, or the like, or a copolymer of at least two of the foregoing thermoplastic materials, or a combination comprising at least one of the foregoing thermoplastic materials.

The filter block as disclosed, wherein the agglomerating agent or agents is in an amount of about 0.01 to about 25 wt % binder, and wherein the mass percent is based on the total mass of the catalyst composite.

The filter block as disclosed, wherein the surface area of the block is at least 10, 15, 25, 50, 75, 100, 200, 300, 400, or 500 m2/g, or from 10 to 1000, 20 to 500, or 15 to 30 m2/g when measured by Brunauer-Emmett-Teller (BET) analysis using N2 adsorption.

A filter cartridge comprising the filter block as disclosed.

A filter device comprising a housing holding the filter cartridge as disclosed.

A filter cartridge fitted with particulate filter materials of composition as disclosed, wherein the particle size of the filter material inserted into the filter cartridge is not more than 0.2, 0.15, 0.1, 0.075, 0.05, or 0.025 times the diameter of the cartridge, or from 0.001 to 0.35, 0.01 to 0.25, 0.05 to 0.2, or 0.075 to 0.1 times the diameter of the cartridge in which it is placed.

A filter mesh bag or cage fitted with filter materials wherein the openings in the mesh bag or cage are small enough to prevent the filter particles from exiting and prevent particulates from entering while allowing liquids to pass easily through the mesh bag or cage.

The filter mesh bag or cage as disclosed, wherein the average diameter of the filter material particles is at least 1.5, 2, 2.5, 3, 5, 10, or 20 times the diameter of the holes or gaps in the walls of the mesh bag or cage.

Shaped filter bodies in the shape of beryl saddles, packing rings, Raschig rings, sponges comprising numerous pores, screens, nets, pleated sheets, or porous cylinders.

Shaped filter bodies such as stars, rings, crosses, waves, or the like, optionally with grooves or ridges, chopped from extrudates of the disclosed material.

A filter cartridge fitted with the disclosed shaped filter bodies.

A fluted filter comprising the disclosed material.

Shaped filter bodies as disclosed, wherein the body comprises a metal or ceramic support with the disclosed material coated thereon.

### BRIEF DESCRIPTION OF THE DRAWINGS

FIG. 1 shows a cylindrical vessel fitted with internal fixed (non-moving) structures incorporating the inventive material that increase fluid-to-surface contact as the fluid flows through the vessel.

FIG. 2A shows one example of a porous cylinder structure containing the inventive material for use in fluid cleaning.

FIG. 2B shows a cross-section of the porous cylinder of FIG. 2A.

FIG. 3 shows a filter cartridge within a filter housing.

FIG. 3 is a flow chart showing a process for purifying water streams with the inventive materials.

FIG. 4 is a flow chart showing a process using the inventive material in a process for purifying a gas such as natural gas, synthesis gas, methane, light hydrocarbons, nitrogen, helium, hydrogen, a refinery gas, or other gas.

FIG. 5 is a flow chart showing a process using the inventive material in a process for purifying a gas such as hydrogen, methane, light hydrocarbons, nitrogen, helium, carbon monoxide, argon, or other gas.

### DETAILED DESCRIPTION OF THE INVENTION

The disclosure of this application includes multiple improvements to the disclosure of U.S. provisional application 63/736,668. For the purposes herein, a material is “catalytically active” if its presence in or on a composition measurably increases the reaction rate of a reactive species in comparison to a blank reaction or one using that same composition without the added material. A turnover frequency (TOF) can be calculated by dividing the number of substrate molecules converted in a unit of time by the number of atoms of the catalytically active component. TOFs can range from less than one per second to hundreds or even thousands per second.

Platinum group metals Pd, Pt, and Rh are often used in quite small amounts as the catalytically active component in catalyst compositions.

Hagemeyer in U.S. Pat. No. 8,927,452 demonstrated the conversion of ethylene to vinyl acetate using catalysts with from 0.05% to 0.8% by mass of Pd or Pt, and the hydrogenation of acetylene containing from 0.01% to 1.0% by mass Pd.

In U.S. Pat. No. 11,484,864 Hara disclosed exhaust gas cleanup using oxide supported catalysts wherein the content of the catalytically active material is 0.001% to 30% by mass of a platinum group metal, i.e. Pt, Pd, or Rh.

Liu et al in (Applied Catalysis B 284(2021) 119716)) demonstrated the effectiveness of atomically separated Pt supported on thin CuxO model surfaces for the preferential oxidation of CO in the presence of H2 over single-site Pt/CuxO catalysts.

Single-atom Pt on Al₂O₃ shows CO-oxidation and selective hydrogenation activity at total Pt loadings as low as 0.02 wt %, with each Pt atom contributing to turnover (Zhang Z., et al. Nature Communications 8, 16100 (2017).

“Thermally Stable Single-Atom Pt/m-Al₂O₃ for Selective Catalysis.”; Ding K., et al. Science 350, 189-192 (2015).

“Single-Atom Pt Catalysts for CO Oxidation.”). Khivantsev et al. (2020) observed efficient NO+CO reduction over Pd/TiO₂ catalysts containing only 0.005-0.05 wt % Pd (Khivantsev K., et al. ChemRev (2020).

Chen et al. (2024) demonstrated a heterogeneous Rh single-atom catalyst operating at only 0.15 mol % Rh, achieving high activity in carbene-insertion reactions (Chen Y., et al. J. Am. Chem. Soc. 146, 11835 (2024). “Heterogeneous Rhodium Single-Atom-Site Catalyst for Carbene Insertion.”

Khivantsev et al. (2020) observed efficient NO+CO reduction over Pd/TiO2 catalysts containing only 0.005-0.05 wt % Pd (“Ultra-Low Amounts of Palladium (0.005-0.05 wt %) Show High Activity for NO Reduction.”).

Zhang has shown have immobilized isolated Rh centers on N-doped supports for hydroformylation and NO-reduction, showing turnover frequencies competitive with nanoparticle Rh (Zhang J., et al. Angew. Chem. Int. Ed. 61, e202114233 (2022), “Rh Single-Atom Catalysts for Hydroformylation on N-Doped Carbon.”)

An object of the invention described herein is a method of purifying water or other fluids by removing PFAS, hydrogen sulfide, organosulfur compounds, and other unwanted impurities from fluid streams by passing the fluid through a filter comprising a housing containing a filtering cartridge containing a medium comprising a composition of granular particles ranging in size from about 0.01 mm to about 15 mm, or one or more shaped filter bodies, and comprising of a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, and the purified aqueous stream is recovered.

For the purposes of this application and the claims contained herein, unless otherwise specified, all listed percentages are determined by total mass of the disclosed components and composition.

Copper oxides are the principal components in the compositions of the present invention that are suitable for H2S removal. In conventional systems that use metallic copper to remove H2S, hydrogen gas can be liberated which can cause age hardening of fixtures, be corrosive to plumbing, and is potentially explosive. However, filter materials rich in copper oxides, particularly cupric oxide (CuO) rather than copper metal, react with H2S to produce H2O instead of H2. Cuprous oxide (Cu2O) is intermediate, producing both Cu and H2O as products.

The chemical equations for the reactions of hydrogen sulfide with copper and copper oxides are:

CuO+H2S=>CuS+H2O

Cu2O+H2S=>CuS+H2O+Cu

Cu+H2S=>CuS+H2

The term ‘copper oxide’ or ‘copper oxides’ as used herein includes mixtures of oxides of copper such as CuO and Cu2O, and up to 10% by mass metallic copper.

In some embodiments the filtering medium comprises granular particles ranging in size from about 0.001 mm to about 15 mm, or one or more shaped filter bodies, and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, wherein the fraction of copper oxides is at least 50% by mass, and wherein the atom ratio of the sum of magnesium, calcium, strontium, and barium to that of copper is at least equal to 0.02. In some embodiments the atom ratio of the sum of magnesium, calcium, strontium, and barium to that of copper is 0.02, 0.05, 0.1, 0.2, 0.25, 0.4, 0.5, or at least equal to 0.05, 0.1, 0.2, or 0.25.

In some embodiments the filtering medium is comprised of at least 0.1, 0.5, 1.0, 3, 5, 8, 10, or 15 mass % activated carbon or 0.1-20, 0.5 to 20, 3 to 20, or 5 to 15 mass % activated carbon. In some embodiments the activated carbon is comprised of at least 0.1, 0.5, 1.0, 3, 5, 8, 10, or 15 mass % or 0.1 to 20, 0.5 to 20, 3 to 20, or 5 to 15 mass % of the sum of magnesium, calcium, strontium, and barium. In some embodiments the filtering medium comprises catalytic quantities of gold, palladium, platinum, or some combination thereof, wherein the atom ratio of the sum of gold, palladium, and platinum to that of copper is at least 0.001, 0.005, 0.01, 0.02, or 0.05, or from 0.001 to 0.1, 0.001 to 0.05, 0.001 to 0.01, or 0.001 to 0.005, or less than 0.1, 0.05, 0.02, 0.01, or 0.05.

The filtering medium composition is prepared as a homogenous mixture with a broad range of grain sizes so that particle sizes can be chosen to minimize fluid bypass during the filtering process regardless of the cross section of the filter. Once the medium is prepared and mixed to ensure uniformity, it is then inserted into the filter cartridge or into such other holder, housing, vessel, mesh bag, or cage through which the contaminant-containing fluid can pass.

To prepare the inventive granular filtering medium, a solution containing the soluble compounds of copper, soluble salts of magnesium, calcium, strontium, and/or barium, and salts of the other metals is contacted with a solution of sodium, potassium, or ammonium hydroxide, bicarbonate, or carbonate, or a mixture of these, in water to form a homogeneous precipitate of hydroxides, carbonates, or both, which are collected by filtration, optionally washed with water, dried, and calcined in air to convert the materials to oxides and drive off the unwanted materials. The calcination may be conducted with air or other O2 containing gas mixture, and may be conducted at a temperature of at least 175, 200, 225, 250, 275, 300, 325, 350, 400, 450, 500, 550, or 600° C., or from 175 to 600, 200 to 300, 225 to 275, 250 to 275, or 300 to 400, 400 to 500, or 500 to 600° C., for a period of at least 0.5, 1, 2, 3, 4, 5, 6, or 10 hours, or from 0.5 to 18, 1 to 6, or 2 to 4 hours, or until the mass of the material changes by less than 1, 2, 3, or 5% in an hour. The calcination may be conducted by holding at a constant temperature for a given time, or may be conducted by heating to a given temperature and then allowing the material to cool slowly in the furnace until the temperature is low enough for it to be easily handled, typically less than about 100° C. The process may be conducted in static air or in flowing air. This process produces a mass of homogeneous solid material that is then broken into irregular granules followed by gravimetric sorting of the broken pieces with a rotary screening machine comprising a connected series of rotary sieves arranged as a column or other suitable sizing apparatus. In a preferred embodiment, the column comprises two sieves. The very fine particles that pass through both sieves may be used for the very small diameter filters or may be agglomerated to form larger particles, blocks, or shaped filter bodies, the particles that pass through the upper sieve but not through the bottom sieve may be used in the medium diameter sized filters, and the largest particles that do not go through the upper sieve may be used for large filters or be recycled back for additional size reduction. With this arrangement, a broad but controlled range of particles is available for packing the filter cartridges or for bulk commercial uses. The result is that few of the particles are wasted. Where the filter cartridge is filled with particles of filter materials, the particle size of the filter material is not more than 0.2, 0.15, 0.1, 0.075, 0.05, or 0.025 times the diameter of the cartridge, or from 0.001 to 0.35, 0.01 to 0.25, 0.05 to 0.2, or 0.075 to 0.1 times the diameter of the cartridge.

In some embodiments the oxides of magnesium, calcium, strontium, or barium are added to pre-existing granular particles ranging in size from about 0.001 mm to about 15 mm, or shaped filter bodies, and comprising a mixture of the oxides of copper and one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, wherein the fraction of copper oxides in the pre-existing granular particles is at least 50% by mass, and wherein the atom ratio of the sum of magnesium, calcium, strontium, and barium to that of copper in the filtering medium is at least equal to 0.02. In some embodiments the atom ratio of the sum of magnesium, calcium, strontium, and barium to that of copper is 0.02, 0.05, 0.1, 0.2, 0.25, 0.4, 0.5, or at least equal to 0.05, 0.1, 0.2, or 0.25.

In some embodiments, the average particle size of the filtering medium is from 0.01 mm (0.0004 inch) to 50 mm (2 inch), 0.05 mm (0.002 inch) to 25 mm (1 inch), 0.1 mm (0.004 inch) to 15 mm (0.6 inch), 0.1 mm (0.004 inch) to 5 mm (0.2 inch), 0.5 mm (0.02 inch) to 2.5 mm (0.1 inch), 5 mm (0.2 inch) to 15 mm (0.6 inch), or 10 mm (0.4 inch) to 25 mm (1 inch), where particle size is measured by dynamic image analysis (DIA), static laser light scattering (SLS, also called laser diffraction), dynamic light scattering (DLS) or sieve analysis, or can pass through sieve size 2 inch (5 cm), 1 inch (2.5 cm), 0.5inch (1.25 cm), US ASTM Standard Sieve size 4 (4.75 mm), 10 (2.00 mm), 14 (1.40 mm), 18 (1.00 mm), 35 (0.50 mm), 70 (0.212 mm), or US sieve size 140 (0.106 mm), but cannot pass through US ASTM Standard sieve size 500 (0.025 mm), 270 (0.053 mm), 140, 70, 35, 18, 14, 10, or 4, or 0.5 inch (1.25 cm). In some embodiments the surface area of the particles is at least 10, 15, 25, 50, 75, 100, 200, 300, 400, or 500 m2/g, or from 10 to 1000, 20 to 500, or 10 to 30 m2/g when measured by Brunauer-Emmett-Teller (BET) analysis using N2 adsorption.

To prepare the inventive granular filtering medium as random sized roughly spherical grains suitable agglomerating agents (binders) may be used to convert the fine powder into particles of desired size to function as filtering media. This process eliminates the loss of very fine particles that are too small for use in the filter cartridge, and also yields a free-flowing media that more easily fills filter cartridges.

The agglomerating agent or agents (binders), provide a means of attachment for the particles of the filter material. The binder may be any material that will agglomerate the particles and is compatible with the reactant mixture. The binder material is also chosen such that the structural integrity of the composite essentially remains constant under reaction conditions. In some embodiments suitable binder materials include non-crosslinked and crosslinked thermoplastic polymers, with an average molecular mass of greater than about 102. When crosslinked thermoplastic polymers are used, an amount of crosslinking may be about 0.1 to about 20%. Preferred thermoplastic polymers include epoxies, phenolics, polyacetals, polyacrylics, polyalkyls, polyamideimides, polyamides, polyanhydrides, polyaramides, polyarylates, polyarylsulfones, polybenzimidazoles, polybenzoxazoles, polybutadienes, polycarbonates, polydibenzofurans, polydioxoisoindolines, polyesters, polyether etherketones, polyether ketone ketones, polyetherimides, polyetherketones, polyethyleneimines, polyethylenes, polyimides, polyisoprenes, polymethacrylonitriles, polymethyl methacrylates, polymethylacrylates, polyolefins, polyoxabicyclononanes, polyoxadiazoles, polyoxindoles, polyoxoisoindolines, polyphthalides, polypiperazines, polypiperidines, polypyrazinoquinoxalines, polypyrazoles, polypyridazines, polypyridines, polypyromellitimides, polyquinoxalines, polysilazanes, polystyrenes, polytriazines, polytriazoles, polyureas, polyurethanes, polyvinyl acetates, polyvinyl alcohols, polyvinyl esters, polyvinyl ethers, polyvinyl ketones, polyvinyl nitriles, polyvinylpyrrolidones, or the like, or a copolymer of at least two of the foregoing thermoplastic materials, or a combination comprising at least one of the foregoing thermoplastic materials.

The filter material particles are mixed with the binder to form a homogeneous or substantially homogeneous mixture. Alternatively, the filter material particles may first be ground into fine particles and then mixed with the binder to form a homogeneous or substantially homogeneous mixture. The mixture of the filter material particles and binder may then be heat and pressure treated, such as with an extruder, compression molder, injection molder, or the like, or a combination comprising at least one of the foregoing, to produce the agglomerate. Depending on the type of binder a lubricant may be used as an additive to facilitate formation of the agglomerate. The lubricant is selected such that filter material properties are essentially not affected. The extrudate can be chopped to the desired size particles. Extrudates can be made with complex shapes that have high surface area such as stars, rings, crosses, waves, or the like, optionally with grooves or ridges to promote both mixing of a fluid that flows over and through a packed bed of pieces of the extrudates and surface contact with the fluid. Any shapes or particles can be calcined either before or after chopping or shaping to remove binders or pore-formers. Any of these shapes can be made from a metal or ceramic material and the inventive material coated onto the surface of the support to form a supported filter medium.

Optionally, the binder may be at least partially removed from the agglomerated filter material by calcination in air. The calcination may be conducted with air or other O2 containing gas mixture, and may be conducted at a temperature of at least 175, 200, 225, 250, 275, 300, 325, 350, 400, 450, 500, 550, or 600° C., or from 175 to 600, 200 to 300, 225 to 275, 250 to 275, or 300 to 400, 400 to 500, or 500 to 600° C., for a period of at least 0.5, 1, 2, 3, 4, 5, 6, or 10 hours, or from 0.5 to 18, 1 to 6, or 2 to 4 hours, or until the mass of the material changes by less than 1, 2, 3, or 5% in an hour.

The pore volume of filter materials needs to be large enough to allow material to flow freely into and through the particles, and yet small enough to provide a robust particle. In some embodiments of the present invention the pore volume of filter materials, whether as small particles, large particles, agglomerates, shaped filter bodies, or filter blocks, is in the range of 0.1 to 0.7, 0.15 to 0.6, 0.2 to 0.5, or 0.25 to 0.4 cm3/g, or at least 0.1, 0.15, 0.2, 0.25, 0.3, 0.35, or 0.45 cm3/g, or no more than 0.75, 0.7, 0.65, 0.6, 0.55, 0.5, or 0.45 cm3/g.

Pore sizes and pore size distributions are often critical to adsorption effectiveness; large pores are needed to permit facile flow of fluids and small pores to provide high surface area. The International Union of Pure and Applied Chemistry (IUPAC) classifies pore sizes into three categories: 1) micropores are those with a width of less than 2 nanometers (nm), 2) mesopores are those with a width between 2 nm and 50 nm, and 3) macropores those with a width greater than 50 nm. In some embodiments of the present invention the fraction of micropores (less than 2 nm) is at least 0.05, 0.1, 0.2, 0.3, 0.4 or 0.5, or from 0.05 to 0.95, 0.2 to 0.8, 0.3 to 0.7, or 0.4 to 0.6, or less than 0.9, 0.8, 0.7, 0.6, 0.5, or 0.4 of the total pore volume as measured by mercury porosimetry or N2 absorption. In some embodiments of the present invention the fraction of mesopores (about 2-50 nm) is at least 0.1, 0.2, 0.3, 0.4 or 0.5, or from 0.1 to 0.95, 0.2 to 0.8, 0.3 to 0.7, or 0.4 to 0.6, or less than 0.9, 0.8, 0.7, 0.6, 0.5, or 0.4 of the total pore volume as measured by mercury porosimetry or N2 absorption. In some embodiments the surface area of the material is at least 10, 15, 25, 50, 75, 100, 200, 300, 400, or 500 m2/g, or from 10 to 1000, 20 to 500, or 15 to 30 m2/g when measured by Brunauer-Emmett-Teller (BET) analysis using N2 adsorption.

In a preferred embodiment, the housing of the filter will be cylindrical, rust-resistant, and the filtering medium will be contained within the cartridge to prevent migration of the medium past the filter, and the filter cartridge will be fitted within the housing such that fluid cannot bypass the cartridge

The filter housing can be composed of anything that will resist the pressure of the fluid being filtered, such as stainless steel, other known corrosion resistant alloys, carbon fiber, compositions such as plastic or fiberglass, etc.

Used filter blocks, shaped filter bodies, or particles can be recycled or regenerated depending on the use of the filter. The useful lifetime of the filter is dependent upon the concentration of the contaminant in the fluid stream being filtered and the rate of flow of the fluid stream.

In another embodiment, an alternate process for filtering sulfur, PFAS, or other contaminant compounds out of water or other fluids may be employed wherein the described filtering composition medium is placed, in bulk without a housing or cartridge, or as loose particles contained in a porous bag, mesh bag, or net to facilitate handling, into existing filtering tanks, with periodic extraction and replacement once the composition becomes loaded with sulfur, PFAS, and other contaminants. In such an arrangement, screens may be placed at the points of entry and exit for the fluid to keep the medium from moving out of the tank and into the connected pipes. Enough medium would be needed to fully cover the programmed level of the filtered tank, such that fluid cannot rise around the medium without being filtered.

Alternatively, filter material could be constrained in mesh bags, nets, or cages that permit the free flow of liquids in and out so it can contact the filter material but prevent the loss of filter particles and the entry of particulates that could clog pores of the filter material; this would facilitate change out of the filter material by simply exchanging one bag or cage for a fresh one. Such mesh bags or cages could be fixed in place as well to target the entry, exit, or other critical locations to maximize effectiveness and could allow for active mixing of the fluid by various mixers while preventing the filter material from being pulverized by the moving parts of any mixer. In some embodiments the average diameter of the filter material particles is at least 1.5, 2, 2.5, 3, 5, 10, or 20 times the diameter of the holes or gaps in the walls of the mesh bag or cage. In some embodiments mesh bags or cages of filter material could be used in concert with similar mesh bags or cages of other types of filter materials such as, but not limited to, activated carbon, charcoal, biochar, peat, wood or forestry waste, agricultural waste, fruit or vegetable shells such as coconut shells, pistachio shells, peanut shells, or other shells, clay or treated clay, zeolites, alumina-silica mixtures, layered double hydroxides, hydrotalcite, ion-exchange resins, or similar porous materials. The advantage of multiple types of mesh bag or cage filters is that each could be replaced when necessary independently of the others, thus allowing for differences in capacity, clogging, poisoning, or effectiveness with time on stream.

In another embodiment, the filtering media is held between screens or porous fibrous films such as filtering cloth with the fluid stream passing through the media which may be planar, cylindrical, pleated, or of any other configuration which permit the fluid to be purified. In some cases the filter material is formed into a fluted filter shape or coated onto a fluted filter of other material to allow for use in combination with particulates held within the flute. Such particles could include other filtering materials, or materials to be extracted wherein the fluted filter removes unwanted materials before they leave the extraction unit. In some embodiments particulates of the filtering media are coated on or held within the pores of a cloth to form a filtering cloth that can be used in combination with or without a packed bed of filtering media.

Other embodiments of the disclosed sorption filter and granular media may include combinations with one or more supplemental fluid filtering components, including additional filtering component(s) taken from the group comprising mechanical filters, absorption filters, adsorption filters, sequestration filters, ion exchange filters, reverse osmosis filters, and so on. In another embodiment, the invention envisions a process wherein the fluid filtering process using the inventive materials is one of a series of filtering processes used to remove contaminants from a fluid stream, wherein the other process is one or more of an activated sludge process, reverse osmosis filters, oxidizing filters, low pressure membranes, biological treatment (including slow sand filtration), or the like.

In a particular embodiment, the inventive filtering medium is either mixed with or packed adjacent to and in series with activated carbon, which is used widely to remove contaminants. Preferably the fluid filter material of this invention is placed downstream of conventional filters such as activated carbon. This arrangement would provide dual filtration for even greater effectiveness at modest cost.

In an alternate embodiment, the fluid filtering cartridge comprises an enriched activated carbon filter with sulfur or PFAS elimination capability, wherein the cartridge is packed with 95% or less by total mass of activated carbon and/or other known active filtering media, optionally mixed with a certain percentage of inert media such as alumina. In this iteration, only the remaining at least 5% of the media packing the cartridge is the inventive filtering medium composition. Activated carbon is produced in several forms: powdered, granular, polymer coated, extruded, beads and woven carbon cloth.

In another embodiment of the invention, the filter of the present invention is one of a series of filtering media used to remove contaminants from a fluid stream, wherein the other filtering media can be one or more of activated carbon, charcoal, biochar, peat, wood or forestry waste, agricultural waste, fruit or vegetable shells such as coconut shells, pistachio shells, peanut shells, or other shells, clay or treated clay, zeolites, alumina-silica mixtures, layered double hydroxides, hydrotalcite, ion-exchange resins, or similar porous materials. Typically, the filter material of this invention is placed after the other filtering media so that the other filtering media remove organic species, salts, or the like, limiting the amount of these materials that pass to the inventive filter material. In some embodiments the sequence of the filtering media can have the filter material of this invention before one or more of the other filtering media or processes.

Alternatively, granular activated carbon may be used as a component of the granular filtering medium. In this iteration, the filtering medium could be comprised of 0.1-20% by mass granular activated carbon for supplemental filtering, more preferably 1-5% by mass.

In another embodiment, the inventive filtering medium may be formed into a porous filter body such as a filter block or shaped filter body such as, without limitation, a porous cylinder, bound together with one or more agglomerating agents to be fitted into a filter cartridge. The filter block or shaped filter body may be held together by agglomerating agent or agents chosen from among polymers, silica sols, porous clay, starch, Isopropyl acetate, methyl cellulose, hexadecanol, octadecanol, paraffin, melted wax, silicone, epoxy resins, and polymerized furfuryl, or one or more thermoplastic polymers chosen from among epoxies, phenolics, polyacetals, polyacrylics, polyalkyls, polyamideimides, polyamides, polyanhydrides, polyaramides, polyarylates, polyarylsulfones, polybenzimidazoles, polybenzoxazoles, polybutadienes, polycarbonates, polydibenzofurans, polydioxoisoindolines, polyesters, polyether ether ketones, polyether ketone ketones, polyetherimides, polyetherketones, polyethyleneimines, polyethylenes, polyimides, polyisoprenes, polymethacrylonitriles, polymethyl methacrylates, polymethylacrylates, polyolefins, polyoxabicyclononanes, polyoxadiazoles, polyoxindoles, polyoxoisoindolines, polyphthalides, polypiperazines, polypiperidines, polypyrazinoquinoxalines, polypyrazoles, polypyridazines, polypyridines, polypyromellitimides, polyquinoxalines, polysilazanes, polystyrenes, polytriazines, polytriazoles, polyureas, polyurethanes, polyvinyl acetates, polyvinyl alcohols, polyvinyl esters, polyvinyl ethers, polyvinyl ketones, polyvinyl nitriles, polyvinylpyrrolidones, or the like, or a copolymer of at least two of the foregoing thermoplastic materials, or a combination comprising at least one of the foregoing thermoplastic materials. In some embodiments the filter block or body can be formed using agglomerating agent or agents is in an amount of about 0.01 to about 25 wt % binder, and wherein the mass percent is based on the total mass of the catalyst composite. In some embodiments the filter block or body has a surface area of at least 10, 15, 25, 50, 75, 100, 200, 300, 400, or 500 m2/g, or from 10 to 1000, 20 to 500, or 15 to 30 m2/g when measured by Brunauer-Emmett-Teller (BET) analysis using N2 adsorption.

In some embodiments a filter block is shaped to fit into a filter cartridge, and the filter block and filter cartridge are cylindrical, with the filter block sized to snugly fit within the filter cartridge, and the filter cartridge designed to fit within the housing such that fluid is not permitted to bypass the filter block. In other embodiments, the filter cartridge comprises a filter container, within which are centered two filter discs, with particulate filtering medium contained between the two filter discs and with a spring or springs between two of the filter discs pushing the media together to prevent media bypass. The filter discs may be ceramic or metal. The filter cartridge is connected to an inlet line on the inlet side of the filter and an outlet located on the opposite end of the filter.

Other shaped filter bodies such as beryl saddles, packing rings, Raschig rings, sponges comprising numerous pores, screens, nets, or porous cylinders may be prepared from the filter material by the aggloermation of very fine particles as described above or by coating onto ceramic or metal structures. The fine particles used for preparing filter blocks or shaped filter bodies, or for coating onto other structures may be prepared by grinding the calcined precipitate of the filter material so that average particle size is less than 500, 250, 100, 75, 50, 25, 15, 10, 5, 2, or 1 microns, or in the range from 1 to 500, 2 to 100, 2 to 25, or 2 to 10 microns.

The drawings and corresponding descriptions of U.S. application Ser. Nos. 17/951,806 and 18/113,288 are incorporated herein by reference.

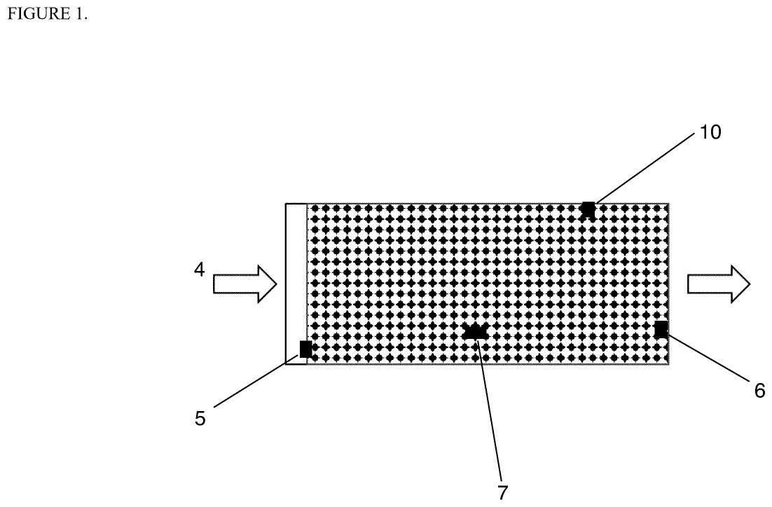

An embodiment of a filter cartridge or vessel using one or more static mixing devices to remove impurities is shown schematically in FIG. 1. In FIG. 1 the vessel is a cylindrical fluid filter cartridge 10 fitted with internal fixed (non-moving) structures that increase fluid-to-surface contact as the fluid flows through the vessel. The fixed structures are embodied as shaped filter bodies 7, and can be in the form of baffles, or spheres with or without passages within them, or shaped articles like beryl saddles, or packing rings, or Raschig rings, or sponges comprising numerous pores, or screens, or nets, or pleated sheets, or other shaped structure or some mixture of these structures that enhances contact of the fluids with the packings. Preferably the fixed structures within the vessel are structures that offer minimal pressure drop while still providing good fluid-solid contact. The fixed structures can be made of the filter material or a ceramic or metal support with filter material coated thereon. In some embodiments ceramic or metal fixed structures may be intermingled with either particulate or shaped filter bodies of the inventive material.

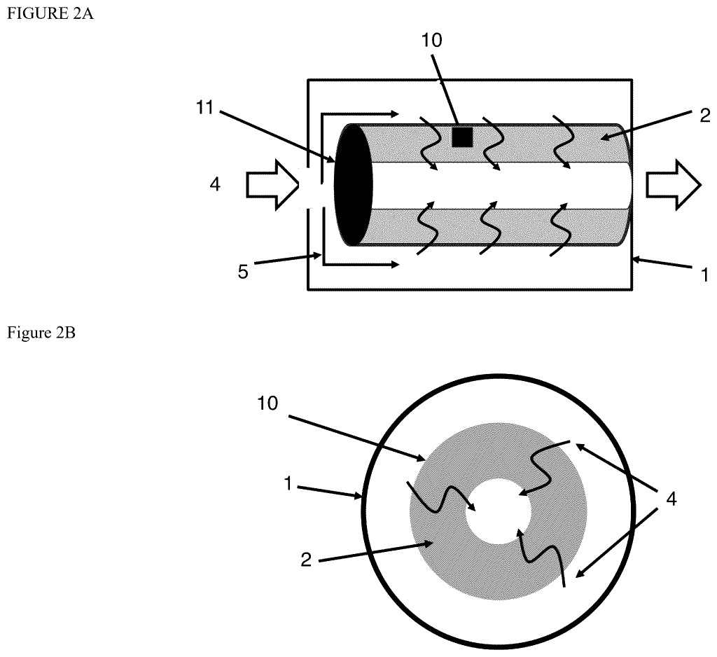

In some embodiments the internal fixed structure is porous cylinder that comprises a cylindrical structure of the filter material or cylinder coated with the filter material that has significant porosity so that fluids can readily pass through. A fluid filter cartridge 10 embodied as a porous, hollow cylinder of filtering medium 2 is situated in a filter housing 1 such that the contaminated fluid enters in a fluid line 4 through a fluid inlet 5, allowing the contaminants to be trapped within the filtering medium as the fluid is forced to pass through the cylinder wall, and the purified fluid to be collected. The porous cylinder structure is configured with an impervious end cap 11 on the end of the filter cartridge facing the fluid inlet 4 as in the side view of FIG. 2A, such that the fluid cannot directly pass into the hollow inside of the cylinder, but is rather forced through the porous filtering medium 2 of the walls of the cylinder. The cylinder can be a closed end cylinder as shown in the Figure, or it can be configured such that the two end surfaces of the open cylinder are impervious to flow and are attached to the housing to prevent the feed fluid from directly entering the internal channel of the cylinder; i.e. the fluid is forced to pass through the pores of the filter material.

FIG. 2B is a cross-section of the configuration of FIG. 2A, with the fluid flow 5 proceeding through the filter medium 2 of cartridge 10 seated within housing 1 and toward the hollow center of the cartridge.

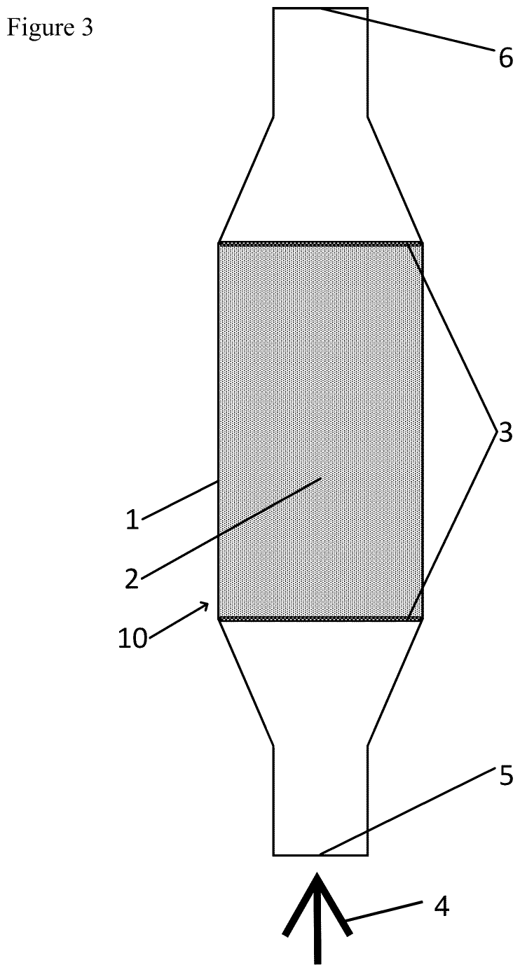

In a preferred embodiment shown in FIG. 3, a contaminant-containing stream is passed through a fluid filter cartridge 10 placed in a fluid filter housing 1 in a fluid line 4, wherein the cartridge is packed with a filtering medium composition 2 of granular particles ranging in size from about 0.001 mm to about 15 mm, or one or more shaped filter bodies, and consisting of a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium, and the purified aqueous stream is recovered. As pictured in FIG. 3, the filter cartridge comprises a cartridge container 3 with two filter discs, with one disc located facing the fluid inlet and one disc located facing the fluid outlet, which cartridge container is inserted within the fluid filter housing. In an alternate embodiment, the fluid filter cartridge may a molded block of filtering medium, and thus no container is required. In another alternate embodiment, the cartridge container is embodied as a mesh bag or cage.

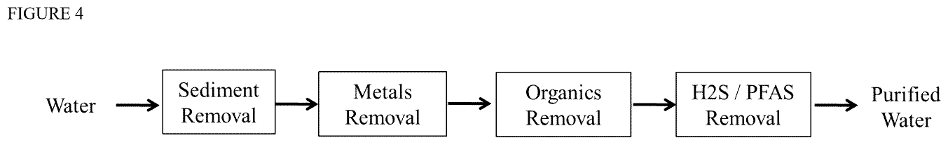

In another preferred embodiment, the filter material described herein is utilized in a water treatment system as shown in the flow chart of FIG. 4 that includes 1) a preliminary treatment to remove settleable organic and inorganic solids by sedimentation, 2) a metals removal trap, 3) an organics trap, or a combination thereof, and 4) one or more filtration steps that include a filtration step using the filter material described herein to remove sulfur compounds, PFAS, or both.

In another preferred embodiment, the filter material described herein is utilized in a water treatment system that includes 1) a preliminary treatment to remove settleable organic and inorganic solids by sedimentation, and materials that will float (scum) by skimming, 2) a first clarifying step to remove particles that settle, 3) an aeration step that facilitates microbial degradation of organic materials, 4) an optional clarifier step, 5, an optional nitrification step, and 6) one or more filtration steps that include a filtration step using the filter material described herein.

In a preferred embodiment the filter material described herein is utilized in a water treatment system reduces PFAS concentration such that the purified stream has a concentration of perfluorooctanoic acid (PFOA) less than 4 ppt, or perfluorooctanesulfonic acid (PFOS) less than 4 ppt, or perfluorohexanesulfonic acid (PFHxS) less than 10 ppt, or hexafluoropropylene oxide-dimer acid (HFPO-DA or GenX) less than 10, or perfluorononanoic acid (PFNA) less than 10 ppt, or some combination thereof. In a preferred embodiment the sum of the concentrations of all PFAS in the purified stream is less than 10, 4, 1, 0.5, 0.2, 0.1, or 0.05 ppb by mass.

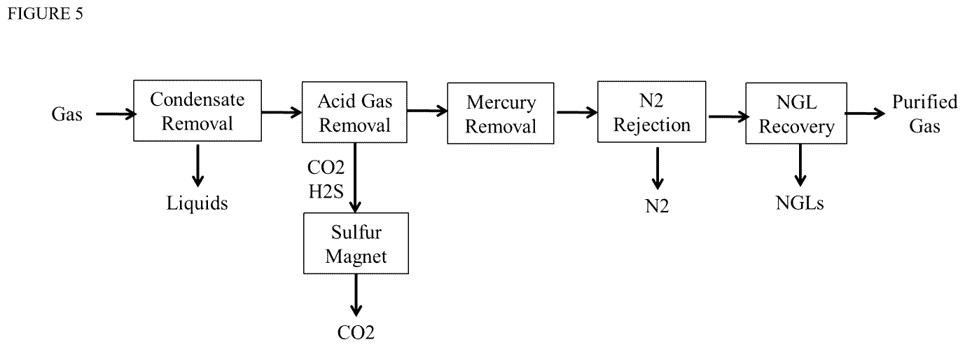

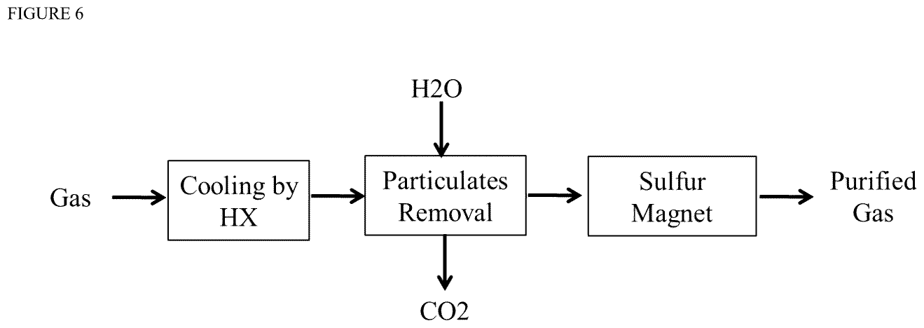

In another preferred embodiment, a process is disclosed wherein the filter material described herein is utilized in natural gas purification, wherein the filter material described herein is utilized in a process shown in the flow chart of FIG. 5 that may include 1) condensate and water removal, 2) acid gas removal, 3) dehydration—moisture removal, 4) mercury removal, 5) nitrogen rejection, 6) natural gas liquids (NGL) recovery, separation, fractionation, and treatment of NGLs, to provide a purified natural gas, wherein a) the acid gases removed in 2) are optionally filtered using the filter material described herein to trap sulfur containing gases, and/or b) the purified natural gas from 6) is further purified (‘sweetened’) by filtering through the filter material described herein to produce a natural gas with less than 1 ppm (parts per million), less than 100 ppb (parts per billion), 50 ppb, 10 ppb 5 ppb, or 1 ppb, or less than 100 ppt (parts per trillion), 50 ppt, 10 ppt, or 5 ppt, or from 1 ppt to 1 ppm, 10 ppt to 100 ppb, 50 ppt to 10 ppb, or 100 ppt to 1 ppb, all by mass sulfur in the gas stream.

In another preferred embodiment, a process is disclosed wherein the filter material described herein is used for synthesis gas purification, wherein the feed synthesis gas is 1) cooled by heat exchange, 2) scrubbed with water to remove particulates, 3) optionally hydrolyzed to convert COS to H2S, 4) scrubbed of acid gases, and 5) dehydrated to produce a purified synthesis gas, wherein a) the acid gases removed in 4) are optionally filtered using the filter material described herein to trap sulfur containing gases, and/or b) the purified synthesis gas from 5) is further purified (‘sweetened’) by filtering through the filter material described herein to produce a synthesis gas with less than 1 ppm (parts per million), less than 100 ppb (parts per billion), 50 ppb, 10 ppb 5 ppb, or 1 ppb, or less than 100 ppt (parts per trillion), 50 ppt, 10 ppt, or 5 ppt, or from 1 ppt to 1 ppm, 10 ppt to 100 ppb, 50 ppt to 10 ppb, or 100 ppt to 1 ppb, all by mass sulfur in the gas stream.

In another preferred embodiment, shown in the flow chart of FIG. 6, a process is disclosed wherein the filter material described herein is used for purification of hydrogen, methane, light hydrocarbons, nitrogen, helium, carbon monoxide, argon, or other gas, or some mixture thereof, wherein the feed gas is 1) optionally cooled by heat exchange, 2) optionally scrubbed with water to remove particulates, and 3) purified by filtering through the filter material described herein to produce a gas stream with less than 1 ppm (parts per million), less than 100 ppb (parts per billion), 50 ppb, 10 ppb 5 ppb, or 1 ppb, or less than 100 ppt (parts per trillion), 50 ppt, 10 ppt, or 5 ppt, or from 1 ppt to 1 ppm, 10 ppt to 100 ppb, 50 ppt to 10 ppb, or 100 ppt to 1 ppb, all by mass sulfur in the gas stream. In an alternate embodiment of the process of FIG. 6, either of step 2 or 3, or both, are mandatory.

### List of Reference Numbers

1 Filter housing
2 Filtering medium
3 Cartridge container with optional filter discs
4 Fluid line
5 Fluid inlet
6 Fluid outlet
7 Shaped filter bodies
10 Fluid filter cartridge
11 End cap

### REGENERATION

Many filter materials cannot be readily regenerated and must be discarded after use, increasing costs and presenting an environmental concern. The filtering media of the present invention are readily regenerated to restore their capacity for removing contaminants. In some embodiments, where the filtering media have been used to remove contaminants from gas streams, the material can be regenerated by controlled combustion in air or other oxygen-containing gas at a temperature of at least 80, 90, 100, 110, 120, 130, 140, 150, 160, or 170 C, or from 80 to 250, 100 to 200, 120 to 180, or 130 to 170 C, or no more than 350, 320, 300, 280, 250, or 220 C. In some embodiments, the temperature can be controlled by diluting the air with inert gas such as N2, CO2, He, Ne, or an oxygen-depleted flue gas, or a mixture of these, to provide an oxygen-containing stream with less than 15, 10, 7, 5, or 2% by volume oxygen or from 0.1 to 15, 2 to 10, or 3 to 7% by volume oxygen.

In some embodiments, wherein the filter material has been used to remove contaminants from aqueous streams the material can be regenerated by controlled combustion as above or by treatment with a dilute basic or acidic water stream wherein the pH of the water stream is no less than 5, 4.5, 4, 3.5, 3, or 2.5, or no more than 3, 3.5, 4, or 5 if it is an acidic stream, or no less than 8, 8.5, 9, 9.5, 10, or 10.5, or no more than 11, 10.5, 10, 9.5, 9, or 8.5 if it is a basic stream, or by a combination of controlled combustion, acid treatment, and basic treatment, wherein either the acid or basic treatment can be conducted first followed by the other treatment. In some embodiments, the regenerated material recovers at least 50, 60, 70, 80, or 90% of its initial capacity or from 50 to 99, 60 to 95, 65 to 90, or 70 to 85% of its initial capacity. The filter media can be regenerated as many times as necessary. The filter media can be regenerated while remaining in a cartridge or the material can be removed from the cartridge, regenerated, and then at least part of it can be returned to service. In some embodiments the acidic stream, or the basic stream, or both can be concentrated to provide a more concentrated solution of sulfuric acid, sulfurour acid, or both.

In some embodiments the filter material that has been used for contaminant removal is dissolved in acidic water solution and then contacted with sufficient solution of sodium, potassium, or ammonium hydroxide, bicarbonate, or carbonate, or a mixture of these, in water to form a homogeneous precipitate of hydroxides, carbonates, or both, which are optionally washed with water, then dried and calcined in air to convert the materials to oxides and drive off the unwanted materials, washed with deionized water, crushed and sieved to provide fresh particles of filter media for further use.

The references recited herein are incorporated herein in their entirety, particularly as they relate to teaching the level of ordinary skill in this art and for any disclosure necessary for the more common understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A process for purifying a contaminant-containing stream comprising the steps:
a. Providing a filtering medium composition comprising granular particles ranging in size from about 0.001 mm to about 15 mm, or one or more shaped filter bodies, and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium,
i. Wherein the fraction of copper oxides is at least 50% by total mass, and
ii. Wherein the atom ratio of the sum of magnesium, calcium, strontium, and barium to that of copper is at least equal to 0.02,
b. Passing a contaminant-containing fluid stream through the fluid filter materials, thereby removing the contaminants and purifying the fluid stream, and
c. Recovering the purified fluid stream.

2. The process of claim 1, wherein the contaminant-containing fluid stream is an aqueous stream.

3. The process of claim 1, wherein the filtering medium composition is at least 80% by total mass of oxides of copper as determined by ICP-MS solution analysis of nitric acid digestions of the medium.

4. The process of claim 1, wherein the filtering medium composition is comprised of 0.1-20% activated carbon by total mass.

5. A process for purifying an aqueous stream, comprising:
a. placing a fluid filter housing comprising a filter cartridge in a fluid line, wherein the filter cartridge is packed with a filtering medium composition of granular particles ranging in size from about 0.001 mm to about 15 mm, or one or more shaped filter bodies, and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium,
i. wherein oxides of copper comprise at least 50% by total mass of the filtering medium composition, and
ii. wherein the atom ratio of the sum of magnesium, calcium, strontium, and barium to that of copper in the filtering medium composition is at least equal to 0.02,
b. passing the aqueous stream through the fluid filter cartridge to remove all contaminants from the aqueous stream, and
c. recovering the purified aqueous stream.

6. The process of claim 5, wherein oxides of copper comprise at least 80% of the filtering medium.

7. A process for purifying aqueous streams, wherein the filter material of claim 1 is one of a series of filtering media used to remove contaminants from a fluid stream, wherein the other filtering media can be one or more of activated carbon, charcoal, biochar, peat, wood or forestry waste, agricultural waste, fruit or vegetable shells such as coconut shells, pistachio shells, peanut shells, or other shells, clay or treated clay, zeolites, alumina-silica mixtures, layered double hydroxides, hydrotalcite, ion-exchange resins, or similar porous materials.

8. The process of claim 1, wherein a sum of concentrations of all PFAS in the purified fluid stream is less than 10, 4, 1, 0.5, 0.2, 0.1, or 0.05 ppb by total mass.

9. The process of claim 1, wherein the purified fluid stream has a concentration of perfluorooctanoic acid (PFOA) less than 4 ppt, or perfluorooctanesulfonic acid (PFOS) less than 4 ppt, or perfluorohexanesulfonic acid (PFHxS) less than 10 ppt, or hexafluoropropylene oxide-dimer acid (HFPO-DA or GenX) less than 10 ppt, or perfluorononanoic acid (PFNA) less than 10 ppt, or some combination thereof.

10. A process for purification of a gas stream comprising hydrogen, methane, light hydrocarbons, nitrogen, helium, carbon monoxide, argon, natural gas, or other gas, or some mixture thereof, comprising the steps:
a. Providing a filtering medium composition comprising granular particles ranging in size from about 0.001 mm to about 15 mm, or one or more shaped filter bodies, and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium,
i. Wherein the fraction of copper oxides is at least 50% by total mass, and
ii. Wherein the atom ratio of the sum of magnesium, calcium, strontium, and barium to that of copper is at least equal to 0.02,
b. Optionally cooling the gas stream by heat exchange,
c. Optionally scrubbing the gas stream with water,
d. Passing the gas stream through the fluid filter materials, thereby removing any contaminants and purifying the fluid stream, and
e. Recovering the purified gas stream.

11. A process for regenerating filtering media composition comprising:
a. Providing filtering media composition of granular particles ranging in size from about 0.001 mm to about 15 mm and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium,
i. Wherein the fraction of copper oxides is at least 50% by total mass,
ii. Wherein the atom ratio of the sum of magnesium, calcium, strontium, and barium to that of copper is 0.02 or higher, and
iii. Wherein the filtering media have been used to remove contaminants from one or more fluid streams, and
b. Combusting the material in air or other oxygen-containing gas.

12. A filtering medium composition of granular particles ranging in size from about 0.001 mm to about 15 mm and comprising a mixture of 1) the oxides of copper, 2) one or more of the oxides of magnesium, calcium, strontium, and barium, and 3) one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium,
a. Wherein the fraction of copper oxides is at least 50% by total mass, and
b. Wherein the atom ratio of the sum of magnesium, calcium, strontium, and barium to that of copper is at least equal to 0.02.

13. The filtering medium composition of claim 12, wherein the filtering medium composition is comprised of 0.1, 0.5, 1.0, 3, 5, 8, 10, or 15 total mass % activated carbon or 0.1-20, 0.5 to 20, 3 to 20, or 5 to 15 total mass % activated carbon.

14. The filtering medium composition of claim 13, wherein the activated carbon is comprised of at least 0.1, 0.5, 1.0, 3, 5, 8, 10, or 15 total mass % of the sum of magnesium, calcium, strontium, and barium or 0.1 to 20, 0.5 to 20, 3 to 20, or 5 to 15 total mass % of the sum of magnesium, calcium, strontium, and barium.

15. The filtering medium composition of claim 12, wherein the oxides of magnesium, calcium, strontium, or barium are added to pre-existing granular particles ranging in size from about 0.001 mm to about 15 mm, or one or more shaped filter bodies, and comprising a mixture of the oxides of copper and one or more of the oxides of aluminum, boron, cerium, cesium, dysprosium, erbium, europium, gadolinium, gallium, hafnium, holmium, indium, iron, lanthanum, lithium, lutetium, manganese, molybdenum, neodymium, praseodymium, samarium, silicon, silver, titanium, vanadium, ytterbium, yttrium, zinc, and zirconium,
c. Wherein the fraction of copper oxides in the pre-existing granular particles is at least 50% by total mass, and
d. Wherein the atom ratio of the sum of magnesium, calcium, strontium, and barium to that of copper in the filtering medium is at least equal to 0.02.

16. The filtering medium of claim 12, wherein the filtering medium has been exposed to sulfur containing fluids and contains at least 5, 10, 20, 25, 30, 35, or 40% by total mass sulfur or from 1 to 50, 5 to 45, 10 to 40, or 10 to 35% by total mass sulfur.

17. A porous filter block composed of the filtering medium composition of claim 1, bound together with one or more agglomerating agents.

18. The porous filter block of claim 17, wherein the agglomerating agent or agents are chosen from among polymers, silica sols, porous clay, starch, Isopropyl acetate, methyl cellulose, hexadecanol, octadecanol, paraffin, melted wax, silicone, epoxy resins, and polymerized furfuryl.

19. A filter cartridge comprising the filter block of claim 17 and, optionally, a filter cartridge container.

20. A filter mesh bag or cage containing the filtering medium composition of claim 17, wherein the average diameter of the filter material particles is at least 1.5, 2, 2.5, 3, 5, 10, or 20 times the diameter of the holes or gaps in the walls of the filter mesh bag or cage.

21. A fluted filter comprising filtering medium composition of claim 12.
